(19) United States
(12) Patent Application Publication
(10) Pub. No.: US 2011/0267557 A1
(43) Pub. Date: Nov. 3, 2011

(54) BACK LIGHT AND LIQUID CRYSTAL DISPLAY DEVICE

(75) Inventors: Seiji IZUTANI, Osaka (JP); Kazutaka HARA, Osaka (JP); Takahiro FUKUOKA, Osaka (JP); Hisae UCHIYAMA, Osaka (JP); Hitotsugu HIRANO, Osaka (JP)

(73) Assignee: NITTO DENKO CORPORATION, Osaka (JP)

(21) Appl. No.: 13/017,442

(22) Filed: Jan. 31, 2011

(30) Foreign Application Priority Data
Jan. 29, 2010 (JP) 2010-018256
Apr. 9, 2010 (JP) 2010-090908
Jul. 16, 2010 (JP) 2010-161848
Jul. 16, 2010 (JP) 2010-161850
Jul. 30, 2010 (JP) 2010-172326

(51) Int. Cl. G02F 1/13357; F21V 7/22

(52) U.S. Cl. 349/61; 362/611; 362/609

(57) ABSTRACT

A back light includes an irradiating portion for applying light to a liquid crystal panel and a heat diffusing member which is in contact with the irradiating portion. The heat diffusing member is made of a thermal conductive sheet containing a plate-like boron nitride particle and the thermal conductivity in a direction perpendicular to the thickness direction of the thermal conductive sheet is 4 W/m·K or more.

### CROSS-REFERENCE TO RELATED APPLICATION

The present application claims priority from Japanese Patent Applications No. 2010-018256 filed on Jan. 29, 2010; No. 2010-090908 filed on Apr. 9, 2010; No. 2010-172326 filed on Jul. 30, 2010; No. 2010-161850 filed on Jul. 16, 2010; and No. 2010-161848 filed on Jul. 16, 2010, the contents of which are hereby incorporated by reference into this application.

### BACKGROUND OF THE INVENTION

1. Field of the Invention

The present invention relates to a back light and a liquid crystal display device, to be specific, to a liquid crystal display device which is preferably used in a television and the like, and a back light used therein.

2. Description of Related Art

Conventionally, a liquid crystal display device has included a liquid crystal panel and a back light for applying light thereto. As a back light of a liquid crystal display device used in a television and the like, a direct type back light has been known. The direct type back light includes a LED (light-emitting diode) or a CCFL (cold cathode fluorescent lamp), and a light reflector disposed on the back side thereof.

There has been proposed, as such a back light, for example, a direct type lighting device provided with a plurality of LEDs and a light reflector disposed in opposed relation to the back side thereof and made of a white PET (ref: for example, Japanese Unexamined Patent Publication No. 2004-302067 (FIG. 25)).

### SUMMARY OF THE INVENTION

However, in the lighting device of Japanese Unexamined Patent Publication No. 2004-302067, the light reflector is made of the white PET whose thermal conductivity is low, so that the heat generated from the LEDs cannot be sufficiently diffused, thereby causing irregularity in temperature. The irregularity in temperature affects an optical film or a glass plate of a liquid crystal display panel, thereby causing irregularity in color of the liquid crystal display device.

It is an object of the present invention to provide a back light capable of efficiently diffusing the heat generated in an irradiating portion and a liquid crystal display device having excellent display performance.

A back light of the present invention includes an irradiating portion for applying light to a liquid crystal panel and a heat diffusing member which is in contact with the irradiating portion, wherein the heat diffusing member is made of a thermal conductive sheet containing a plate-like boron nitride particle and the thermal conductivity in a direction perpendicular to the thickness direction of the thermal conductive sheet is 4 W/m·K or more.

In the back light of the present invention, it is preferable that the irradiating portion includes a light source and the heat diffusing member is in contact with the light source, and the irradiating portion further includes a casing which houses the light source and the heat diffusing member is in contact with the inner side surface of the casing.

In the back light of the present invention, it is preferable that the irradiating portion includes a light source and a casing which houses the light source, wherein the heat diffusing member is in contact with the outer side surface of the casing.

In the back light of the present invention, it is preferable that the irradiating portion includes a light source and a light guide portion where the light from the light source is guided, wherein the heat diffusing member is in contact with the light guide portion.

In the back light of the present invention, it is preferable that the heat diffusing member serves as a light reflector for reflecting light.

A liquid crystal display device of the present invention includes a liquid crystal panel and the back light described above.

In the back light of the present invention, the heat generated in the irradiating portion can be efficiently diffused toward the direction perpendicular to the thickness direction of the thermal conductive sheet by the heat diffusing member.

Therefore, it is possible to prevent irregularity in temperature from occurring in the irradiating portion.

As a result, the liquid crystal display device of the present invention is capable of preventing irregularity in temperature of the back light from affecting the liquid crystal panel, thereby capable of improving the display performance.

### BRIEF DESCRIPTION OF THE DRAWINGS

FIG. 1 shows a liquid crystal display device including an embodiment (embodiment of a direct type including a light-emitting diode) of a back light of the present invention:
(a) illustrating a perspective view, and
(b) illustrating a sectional view.

FIG. 2 shows a perspective view of a thermal conductive sheet.

FIG. 3 shows process drawings for describing a method for producing the thermal conductive sheet:
(a) illustrating a step of hot pressing a mixture or a laminated sheet,
(b) illustrating a step of dividing the pressed sheet into a plurality of pieces, and
(c) illustrating a step of laminating the divided sheets.

FIG. 4 shows a liquid crystal display device including another embodiment (embodiment of the direct type including a cold cathode fluorescent lamp) of the back light of the present invention:
(a) illustrating a perspective view, and
(b) illustrating a sectional view.

FIG. 5 shows a liquid crystal display device including another embodiment (embodiment of the direct type and the back wall of a casing being a wavy shape in cross section) of the back light of the present invention:
(a) illustrating a perspective view, and
(b) illustrating a sectional view.

FIG. 6 shows a liquid crystal display device including another embodiment (embodiment of the direct type and the back wall of the casing being a zig-zag shape in cross section) of the back light of the present invention:
(a) illustrating a perspective view, and
(b) illustrating a sectional view.

FIG. 7 shows a liquid crystal display device including another embodiment (embodiment of the direct type and the casings being provided corresponding to each of the light-emitting diodes) of the back light of the present invention:
(a) illustrating a perspective view, and
(b) illustrating a sectional view.

FIG. 8 shows a liquid crystal display device including another embodiment (embodiment of a side light type including the light-emitting diode) of the back light of the present invention:
(a) illustrating a perspective view, and
(b) illustrating a sectional view.

FIG. 9 shows a liquid crystal display device including another embodiment (embodiment of the side light type including the cold cathode fluorescent lamp) of the back light of the present invention:
(a) illustrating a perspective view, and
(b) illustrating a sectional view.

FIG. 10 shows a perspective view of a test device of type I in a bend resistance test (before the bend resistance test).

FIG. 11 shows a perspective view of a test device of type I in a bend resistance test (in the middle of the bend resistance test).

### DETAILED DESCRIPTION OF PREFERRED EMBODIMENTS

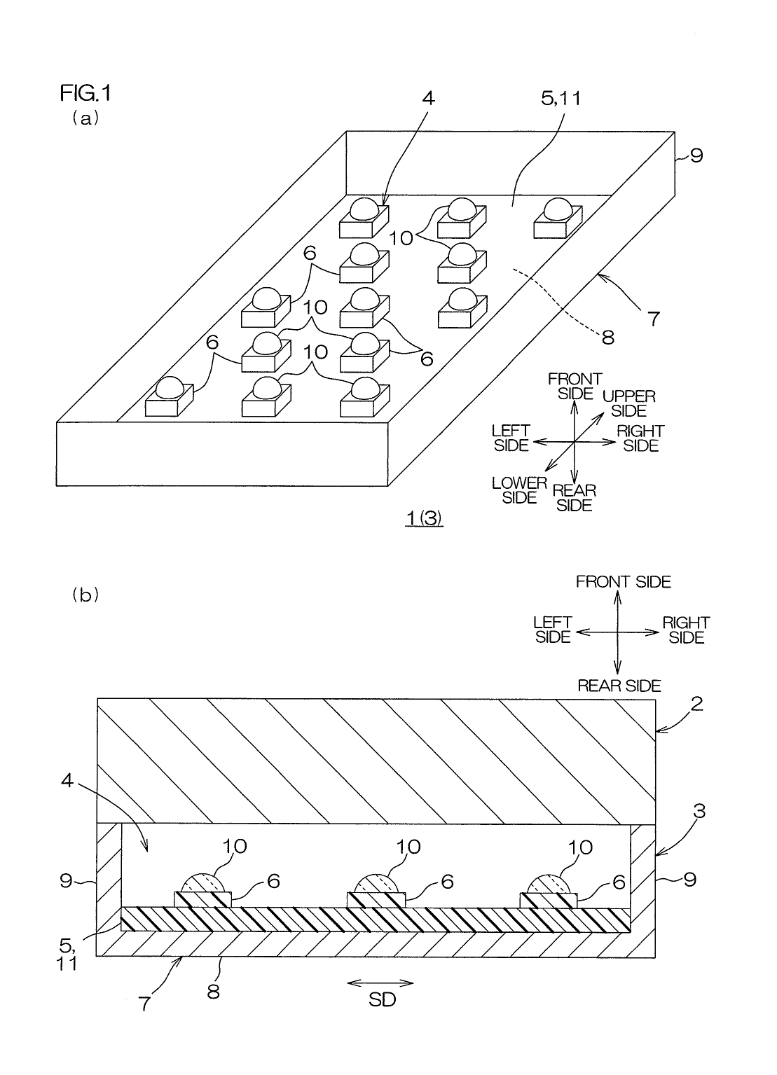

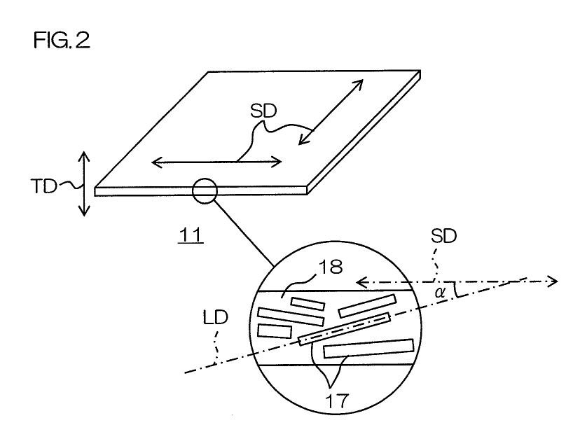

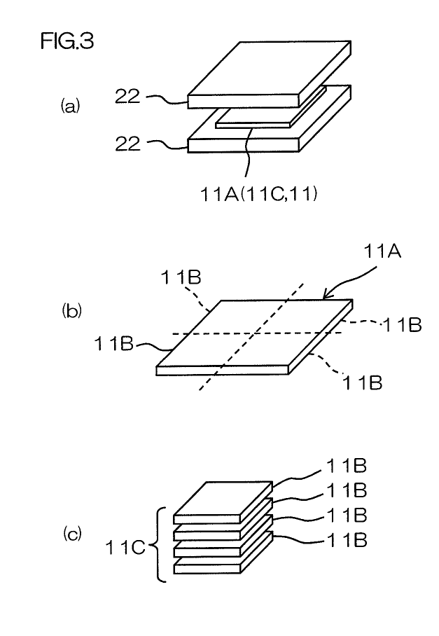

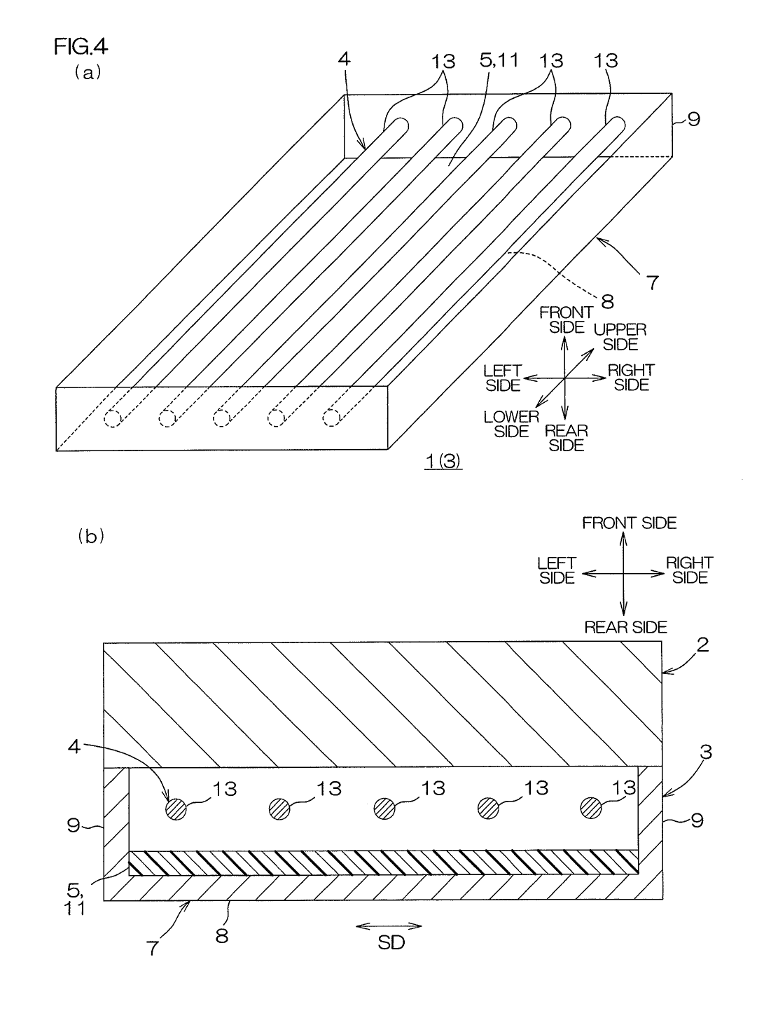

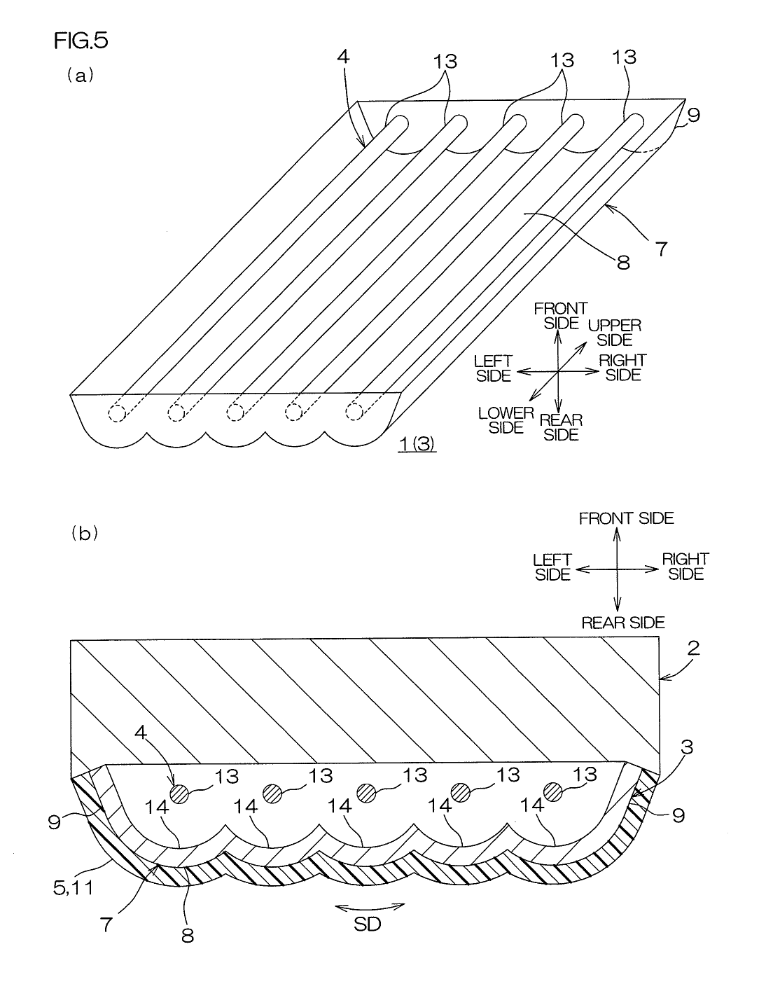

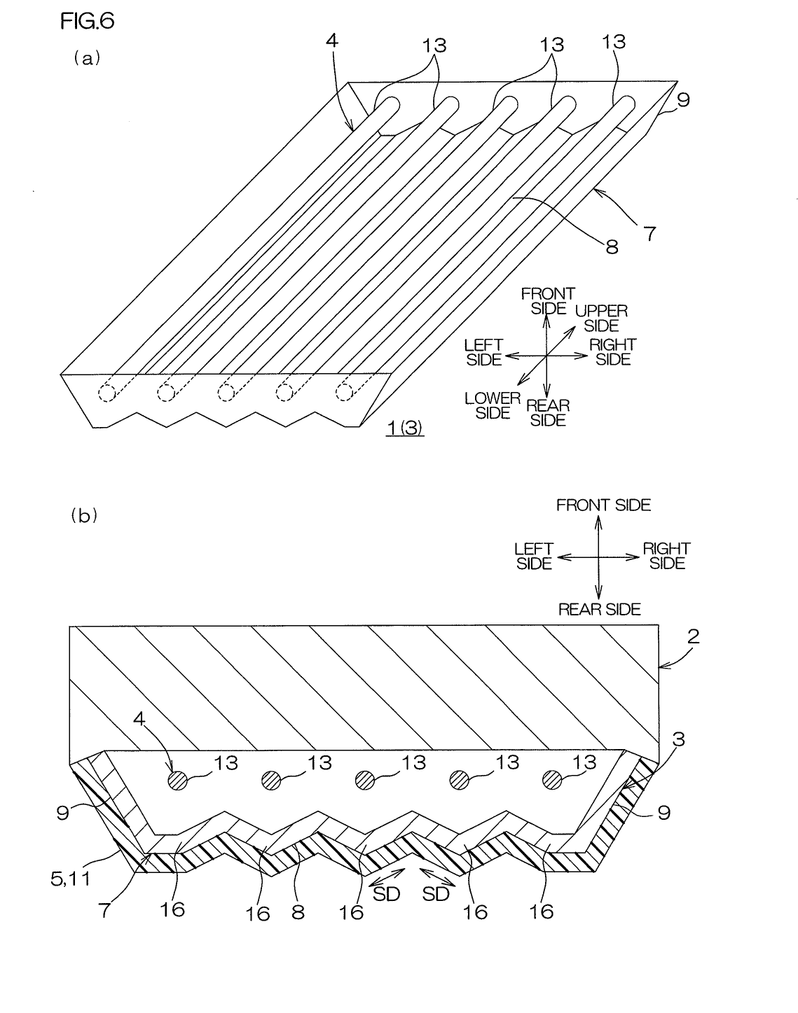

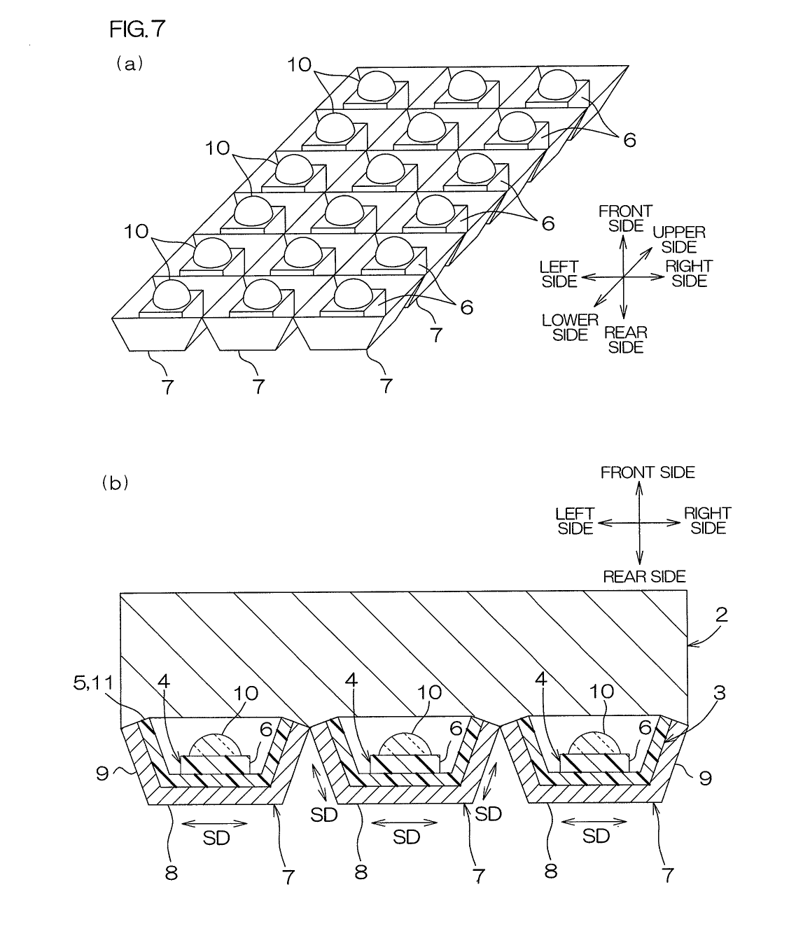

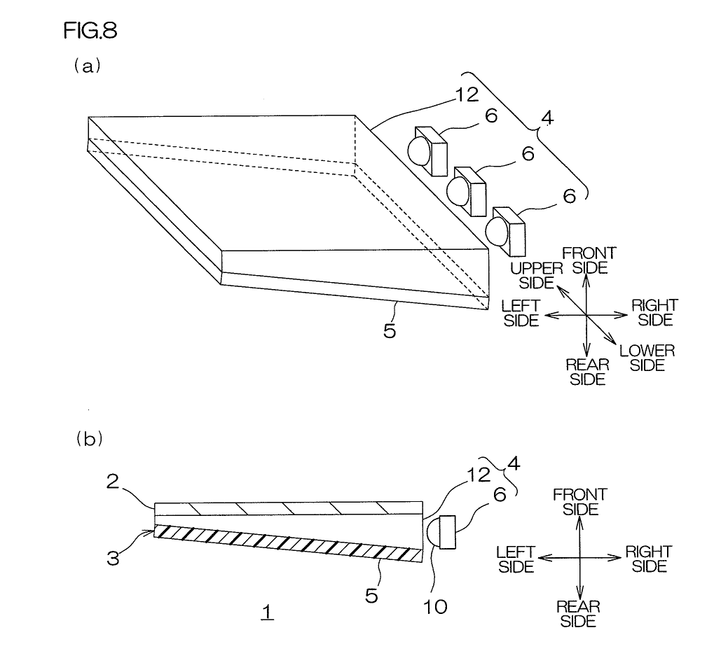

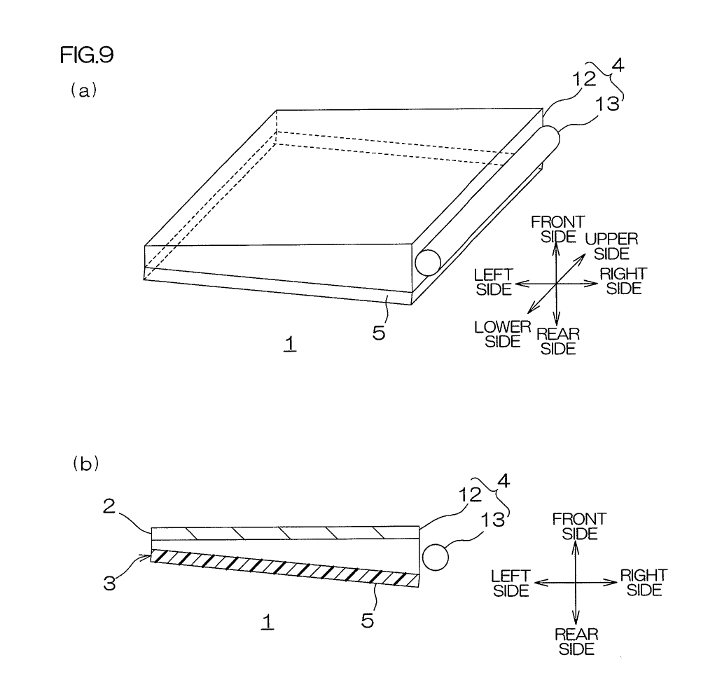

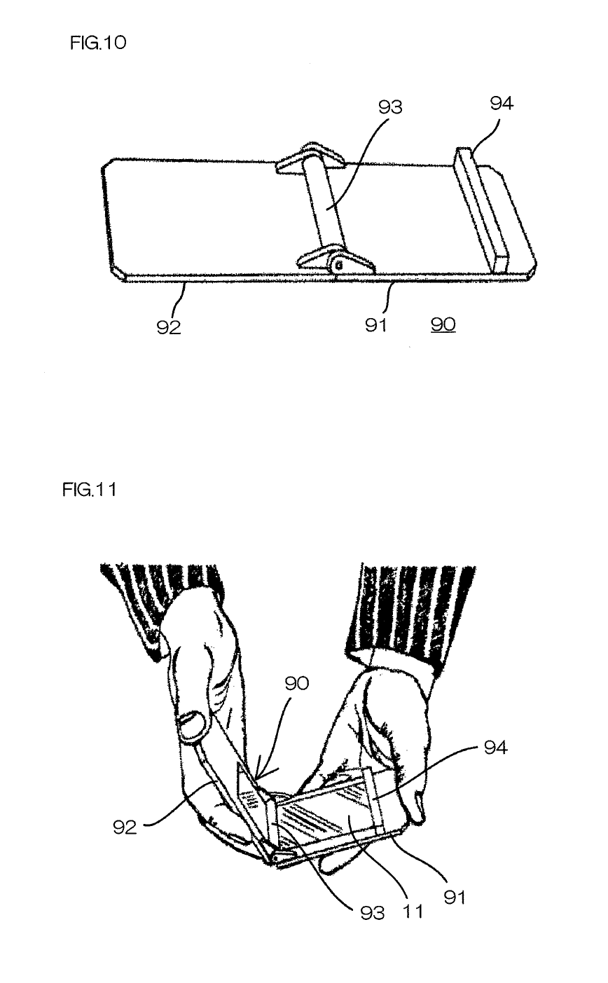

FIG. 1 shows a liquid crystal display device including an embodiment (embodiment of a direct type including a light-emitting diode) of a back light of the present invention. FIG. 2 shows a perspective view of a thermal conductive sheet. FIG. 3 shows process drawings for describing a method for producing the thermal conductive sheet.

In FIG. 1 (b), the directions are described as follows: the upper side is the front side, the lower side being the rear side, the right side being the right side, the left side being the left side, the depth side of the paper being the upper side, and the near side of the paper being the lower side. The directions of each of the drawings hereinafter conform to the directions in FIG. 1 (b). In FIG. 1 (a), a liquid crystal panel 2 is omitted to clearly show the arrangement of a light-emitting diode 6.

In FIG. 1 (b), a liquid crystal display device 1 includes the liquid crystal panel 2 and a back light 3.

A known panel is used for the liquid crystal panel 2. The liquid crystal panel 2 is provided on the front side of the liquid crystal display device 1, formed into a generally flat plate shape extending along the right-left direction and the up-down direction, and formed by laminating a liquid crystal layer, a transparent conductive film, an oriented film, and a polarizing plate and the like in the front-rear direction.

The back light 3 is disposed in opposed relation to the back side of the liquid crystal panel 2. The back light 3 is constructed as a direct type back light, including an irradiating portion 4 for applying light to the liquid crystal panel 2 and a heat diffusing member 5 which is in contact with the irradiating portion 4.

The irradiating portion 4 is provided with a casing 7 and as a light source, a plurality of the light-emitting diodes 6 which are housed in the casing 7.

The casing 7 is formed into a generally box shape with the front side open, integrally including a back wall 8 which is formed into a generally rectangular flat plate shape in front view and side walls 9 which extend from the circumference end portions of the back wall 8 toward the front side. The front end surfaces of the side walls 9 are connected to the circumference end portion of the back surface of the liquid crystal panel 2. In the back wall 8, a plurality of first holes (not shown) passing through the front-rear direction so as to correspond to each of the light-emitting diodes 6 are formed. On the back surface of the back wall 8, a wiring pattern (not shown) which is connected to a power source (not shown) is formed. The wiring pattern is formed into a pattern facing each of the first holes.

Examples of the material for forming the casing 7 include a metal material such as aluminum, stainless steel, iron, and copper, a resin material such as polyethylene terephthalate and acrylic resin, and a ceramic material such as aluminum nitride. Of these, the metal material and the ceramic material are preferably used.

The light-emitting diodes 6 are disposed on the front side of the back wall 8 and a plurality thereof are arranged at spaced intervals to each other in the right-left direction and the up-down direction. Each of the light-emitting diodes 6 is formed into a generally rectangular flat plate shape in front view. To be specific, an example of the light-emitting diodes 6 includes a white light-emitting diode (white LED) which emits white light.

On the front surface of the light-emitting diodes 6, a lens 10 which is formed into a generally semi-sphere shape made of a silicone resin and the like is provided.

The heat diffusing member 5 is housed in the casing 7, provided on the front surface of the back wall 8, and sandwiched between the back wall 8 and the light-emitting diodes 6 in the front-rear direction. To be specific, the heat diffusing member 5 is in contact with the entire front surface of the back wall 8 and the lower end portions of the inner surfaces of the side walls 9 (that is, the inner side surface of the casing 7) and is in contact with the entire back surfaces of the light-emitting diodes 6. A plurality of second holes passing through the heat diffusing member 5 in the front-rear direction are formed at the same position as each of the first holes (not shown) in the back wall 8 described above.

The light-emitting diodes 6 are connected to the wiring pattern via the above-described second holes and first holes.

The heat diffusing member 5 is made of a thermal conductive sheet 11.

To be specific, the thermal conductive sheet 11 contains boron nitride (BN) particles as an essential component, and further contains, for example, a resin component.

The boron nitride particles are formed into a plate-like (or flake-like) shape, and are dispersed so as to be orientated in a predetermined direction (described later) in the thermal conductive sheet 11.

The boron nitride particles have an average length in the longitudinal direction (maximum length in the direction perpendicular to the plate thickness direction) of, for example, 1 to 100 μm, or preferably 3 to 90 μm. The boron nitride particles have an average length in the longitudinal direction of, 5 μm or more, preferably 10 μm or more, more preferably 20 μm or more, even more preferably 30 μm or more, or most preferably 40 μm or more, and usually has an average length in the longitudinal direction of, for example, 100 μm or less, or preferably 90 μm or less.

The average thickness (the length in the thickness direction of the plate, that is, the length in the short-side direction of the particles) of the boron nitride particles is, for example, 0.01 to 20 μm, or preferably 0.1 to 15 μm.

The aspect ratio (length in the longitudinal direction/thickness) of the boron nitride particles is, for example, 2 to 10000, or preferably 10 to 5000.

The average particle size of the boron nitride particles as measured by a light scattering method is, for example, 5 μm or more, preferably 10 μm or more, more preferably 20 μm or more, particularly preferably 30 μm or more, or most preferably 40 μm or more, and usually is 100 μm or less.

The average particle size as measured by the light scattering method is a volume average particle size measured with a dynamic light scattering type particle size distribution analyzer.

When the average particle size of the boron nitride particles as measured by the light scattering method is below the above-described range, the thermal conductive sheet 11 may become fragile, and handleability may be reduced.

The bulk density (JIS K 5101, apparent density) of the boron nitride particles is, for example, 0.3 to 1.5 g/cm³, or preferably 0.5 to 1.0 g/cm³.

As the boron nitride particles, a commercially available product or processed goods thereof can be used. Examples of commercially available products of the boron nitride particles include the “PT” series (for example, “PT-110”) manufactured by Momentive Performance Materials Inc., and the “SHOBN®UHP” series (for example, “SHOBN®UHP-1”) manufactured by Showa Denko K.K.

The resin component is a component that is capable of dispersing the boron nitride particles, i.e., a dispersion medium (matrix) in which the boron nitride particles are dispersed, including, for example, resin components such as a thermosetting resin component and a thermoplastic resin component.

Examples of the thermosetting resin component include epoxy resin, thermosetting polyimide, phenol resin, urea resin, melamine resin, unsaturated polyester resin, diallyl phthalate resin, silicone resin, and thermosetting urethane resin.

Examples of the thermoplastic resin component include polyolefin (for example, polyethylene, polypropylene, and ethylene-propylene copolymer), acrylic resin (for example, polymethyl methacrylate), polyvinyl acetate, ethylene-vinyl acetate copolymer, polyvinyl chloride, polystyrene, polyacrylonitrile, polyamide, polycarbonate, polyacetal, polyethylene terephthalate, polyphenylene oxide, polyphenylene sulfide, polysulfone, polyether sulfone, poly ether ether ketone, polyallyl sulfone, thermoplastic polyimide, thermoplastic urethane resin, polyamino-bismaleimide, polyamide-imide, polyether-imide, bismaleimide-triazine resin, polymethylpentene, fluorine resin, liquid crystal polymer, olefin-vinyl alcohol copolymer, ionomer, polyarylate, acrylonitrile-ethylene-styrene copolymer, acrylonitrile-butadiene-styrene copolymer, and acrylonitrile-styrene copolymer.

These resin components can be used alone or in combination of two or more.

Of the thermosetting resin components, epoxy resin is preferably used.

The epoxy resin is in a state of liquid, semi-solid, or solid under normal temperature.

To be specific, examples of the epoxy resin include aromatic epoxy resins such as bisphenol epoxy resin (for example, bisphenol A epoxy resin, bisphenol F epoxy resin, bisphenol S epoxy resin, hydrogenated bisphenol A epoxy resin, dimer acid-modified bisphenol epoxy resin, and the like), novolak epoxy resin (for example, phenol novolak epoxy resin, cresol novolak epoxy resin, biphenyl epoxy resin, and the like), naphthalene epoxy resin, fluorene epoxy resin (for example, bisaryl fluorene epoxy resin and the like), and triphenylmethane epoxy resin (for example, trishydroxyphenylmethane epoxy resin and the like); nitrogen-containing-cyclic epoxy resins such as triepoxypropyl isocyanurate (triglycidyl isocyanurate) and hydantoin epoxy resin; aliphatic epoxy resin; alicyclic epoxy resin (for example, dicyclo ring-type epoxy resin and the like); glycidylether epoxy resin; and glycidylamine epoxy resin.

These epoxy resins can be used alone or in combination of two or more.

A combination of a liquid epoxy resin and a solid epoxy resin is preferable, or a combination of a liquid aromatic epoxy resin and a solid aromatic epoxy resin is even more preferable. To be specific, examples of such combinations include a combination of a liquid bisphenol epoxy resin and a solid triphenylmethane epoxy resin, and a combination of a liquid bisphenol epoxy resin and a solid bisphenol epoxy resin.

As an epoxy resin, preferably, a semi-solid epoxy resin is used alone, or more preferably, a semi-solid aromatic epoxy resin is used alone. Examples of those epoxy resins include, to be specific, a semi-solid fluorene epoxy resin.

A combination of a liquid epoxy resin and a solid epoxy resin, or a semi-solid epoxy resin improves conformability to irregularities (described later) of the thermal conductive sheet 11.

The epoxy resin has an epoxy equivalent of, for example, 100 to 1000 g/eqiv., or preferably 180 to 700 g/eqiv., and has a softening temperature (ring and ball test) of, for example, 80° C. or less (to be specific, 20 to 80° C.), or preferably 70° C. or less (to be specific, 25 to 70° C.).

The epoxy resin has a melt viscosity at 80° C. of, for example, 10 to 20000 mPa·s, or preferably 50 to 15000 mPa·s. When two or more epoxy resins are used in combination, the melt viscosity of the mixture of these epoxy resins is set within the above-described range.

Furthermore, when an epoxy resin that is solid under normal temperature and an epoxy resin that is liquid under normal temperature are used in combination, for example, a first epoxy resin having a softening temperature of below 45° C., or preferably below 35° C., and a second epoxy resin having a softening temperature of 45° C. or more, or preferably 55° C. or more are used in combination. In this way, the kinetic viscosity (in conformity with JIS K 7233, described later) of the resin component (mixture) can be set to a desired range, thereby improving conformability to irregularities of the thermal conductive sheet 11.

The epoxy resin can also be prepared as an epoxy resin composition containing, for example, an epoxy resin, a curing agent, and a curing accelerator.

The curing agent is a latent curing agent (epoxy resin curing agent) that can cure the epoxy resin by heating, and examples thereof include an imidazole compound, an amine compound, an acid anhydride compound, an amide compound, a hydrazide compound, and an imidazoline compound. In addition to the above-described compounds, a phenol compound, a urea compound, and a polysulfide compound can also be used.

Examples of the imidazole compound include 2-phenyl imidazole, 2-methyl imidazole, 2-ethyl-4-methyl imidazole, and 2-phenyl-4-methyl-5-hydroxymethyl imidazole.

Examples of the amine compound include aliphatic polyamines such as ethylene diamine, propylene diamine, diethylene triamine, triethylene tetramine, and aromatic polyamines such as metha phenylenediamine; diaminodiphenyl methane; and diaminodiphenyl sulfone.

Examples of the acid anhydride compound include phthalic anhydride, maleic anhydride, tetrahydrophthalic anhydride, hexahydrophthalic anhydride, 4-methyl-hexahydrophthalic anhydride, methyl nadic anhydride, pyromelletic anhydride, dodecenylsuccinic anhydride, dichloro succinic anhydride, benzophenone tetracarboxylic anhydride, and chlorendic anhydride.

Examples of the amide compound include dicyandiamide and polyamide.

An example of the hydrazide compound includes adipic acid dihydrazide.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline.

These curing agents can be used alone or in combination of two or more.

A preferable example of the curing agent is an imidazole compound.

Examples of the curing accelerator include tertiary amine compounds such as triethylenediamine and tri-2,4,6-dimethylaminomethylphenol; phosphorus compounds such as triphenylphosphine, tetraphenylphosphoniumtetraphenylborate, and tetra-n-butylphosphonium-o,o-diethylphosphorodithioate; a quaternary ammonium salt compound; an organic metal salt compound; and derivatives thereof. These curing accelerators can be used alone or in combination of two or more.

In the epoxy resin composition, the mixing ratio of the curing agent is, for example, 0.5 to 50 parts by mass, or preferably 1 to 10 parts by mass per 100 parts by mass of the epoxy resin, and the mixing ratio of the curing accelerator is, for example, 0.1 to 10 parts by mass, or preferably 0.2 to 5 parts by mass per 100 parts by mass of the epoxy resin.

The above-described curing agent, and/or the curing accelerator can be prepared and used, as necessary, as a solution, i.e., the curing agent and/or the curing accelerator dissolved in a solvent; and/or as a dispersion liquid, i.e., the curing agent and/or the curing accelerator dispersed in a solvent.

Examples of the solvent include organic solvents including ketones such as acetone and methyl ethyl ketone, esters such as ethyl acetate, and amides such as N,N-dimethylformamide. Examples of the solvent also include aqueous solvents including water, and alcohols such as methanol, ethanol, propanol, and isopropanol. A preferable example is an organic solvent, and more preferable examples are ketones and amides.

Of the thermoplastic resin components, polyolefin is preferably used.

Preferable examples of polyolefin are polyethylene and ethylene-propylene copolymer.

Examples of polyethylene include a low density polyethylene and a high density polyethylene.

Examples of ethylene-propylene copolymer include a random copolymer, a block copolymer, or a graft copolymer of ethylene and propylene.

These polyolefins can be used alone or in combination of two or more.

The polyolefins have a weight average molecular weight and/or a number average molecular weight of, for example, 1000 to 10000.

The polyolefin can be used alone, or can be used in combination of two or more.

The resin component has a kinetic viscosity as measured in conformity with the kinetic viscosity test of JIS K 7233 (bubble viscometer method) (temperature: 25° C.±0.5° C., solvent: butyl carbitol, resin component (solid content) concentration: 40 mass %) of, for example, 0.22×10⁻⁴ to 2.00×10⁻⁴ m²/s, preferably 0.3×10⁻⁴ to 1.9×10⁻⁴ m²/s, or more preferably 0.4×10⁻⁴ to 1.8×10⁻⁴ m²/s. The above-described kinetic viscosity can also be set to, for example, 0.22×10⁻⁴ to 1.00×10⁻⁴ m²/s, preferably 0.3×10⁻⁴ to 0.9×10⁻⁴ m²/s, or more preferably 0.4×10⁻⁴ to 0.8×10⁻⁴ m²/s.

When the kinetic viscosity of the resin component exceeds the above-described range, excellent flexibility and conformability to irregularities (described later) may not be given to the thermal conductive sheet 11. On the other hand, when the kinetic viscosity of the resin component is below the above-described range, boron nitride particles may not be oriented in a predetermined direction.

In the kinetic viscosity test in conformity with JIS K 7233 (bubble viscometer method), the kinetic viscosity of the resin component is measured by comparing the bubble rising speed of a resin component sample with the bubble rising speed of criterion samples (having a known kinetic viscosity), and determining the kinetic viscosity of the criterion sample having a matching rising speed to be the kinetic viscosity of the resin component.

The specific gravity of the resin component is, for example, 1.0 to 1.5, or preferably 1.1 to 1.2.

In the thermal conductive sheet 11, the proportion of the volume-based boron nitride particle content (solid content, that is, the volume percentage of boron nitride particles relative to a total volume of the resin component and the boron nitride particles) is, for example, 35 vol % or more, preferably 60 vol % or more, or more preferably 75 vol % or more, and usually, for example, 95 vol % or less, or preferably 90 vol % or less.

When the proportion of the volume-based boron nitride particle content is below the above-described range, the boron nitride particles may not be oriented in a predetermined direction in the thermal conductive sheet 11. On the other hand, when the proportion of the volume-based boron nitride particle content exceeds the above-described range, the thermal conductive sheet 11 may become fragile, and handleability and conformability to irregularities (described later) may be reduced.

The mass-based mixing ratio of the boron nitride particles relative to 100 parts by mass of the total amount (total solid content) of the components (boron nitride particles and resin component) forming the thermal conductive sheet 11 is, for example, 40 to 95 parts by mass, or preferably 65 to 90 parts by mass, and the mass-based mixing ratio of the resin component relative to 100 parts by mass of the total amount of the components forming the thermal conductive sheet 11 is, for example, 5 to 60 parts by mass, or preferably 10 to 35 parts by mass. The mass-based mixing ratio of the boron nitride particles relative to 100 parts by mass of the resin component is, for example, 60 to 1900 parts by mass, or preferably 185 to 900 parts by mass.

When two epoxy resins (a first epoxy resin and a second epoxy resin) are used in combination, the mass ratio (mass of the first epoxy resin/mass of the second epoxy resin) of the first epoxy resin relative to the second epoxy resin can be set appropriately in accordance with the softening temperature and the like of the epoxy resins (the first epoxy resin and the second epoxy resin). For example, the mass ratio of the first epoxy resin relative to the second epoxy resin is 1/99 to 99/1, or preferably 10/90 to 90/10.

In the resin component, in addition to the above-described components (polymer), for example, a polymer precursor (for example, a low molecular weight polymer including oligomer), and/or a monomer are contained.

Next, a method for producing a thermal conductive sheet 11 is described with reference to FIG. 2 and FIG. 3.

In this method, first, the above-described components are blended at the above-described mixing ratio and are stirred and mixed, thereby preparing a mixture.

In the stirring and mixing, in order to mix the components efficiently, for example, the solvent may be blended therein with the above-described components, or, for example, the resin component (preferably, the thermoplastic resin component) can be melted by heating.

Examples of the solvent include the above-described organic solvents. When the above-described curing agent and/or the curing accelerator are prepared as a solvent solution and/or a solvent dispersion liquid, the solvent of the solvent solution and/or the solvent dispersion liquid can also serve as a mixing solvent for the stirring and mixing without adding a solvent during the stirring and mixing. Or, in the stirring and mixing, a solvent can be further added as a mixing solvent.

In the case when the stirring and mixing is performed using a solvent, the solvent is removed after the stirring and mixing.

To remove the solvent, for example, the mixture is allowed to stand at room temperature for 1 to 48 hours; heated at 40 to 100° C. for 0.5 to 3 hours; or heated under a reduced pressure atmosphere of, for example, 0.001 to 50 kPa, at 20 to 60° C., for 0.5 to 3 hours.

When the resin component is to be melted by heating, the heating temperature is, for example, a temperature in the neighborhood of or exceeding the softening temperature of the resin component, to be specific, 40 to 150° C., or preferably 70 to 140° C.

Next, in this method, the obtained mixture is hot-pressed.

To be specific, as shown in FIG. 3 (a), as necessary, for example, the mixture is hot-pressed with two releasing films 22 sandwiching the mixture, thereby producing a pressed sheet 1A. Conditions for the hot-pressing are as follows: a temperature of, for example, 50 to 150° C., or preferably 60 to 140° C.; a pressure of, for example, 1 to 100 MPa, or preferably 5 to 50 MPa; and a duration of, for example, 0.1 to 100 minutes, or preferably 1 to 30 minutes.

More preferably, the mixture is hot-pressed under vacuum. The degree of vacuum in the vacuum hot-pressing is, for example, 1 to 100 Pa, or preferably 5 to 50 Pa, and the temperature, the pressure, and the duration are the same as those described above for the hot-pressing.

When the temperature, the pressure, and/or the duration in the hot-pressing is outside the above-described range, there may be a case where a porosity P (described later) of the thermal conductive sheet 11 cannot be adjusted to give a desired value.

The pressed sheet 1A obtained by the hot-pressing has a thickness of, for example, 50 to 1000 μm, or preferably 100 to 800 μm.

Next, in this method, as shown in FIG. 3 (b), the pressed sheet 1A is divided into a plurality of pieces (for example, four pieces), thereby producing a divided sheet 1B (dividing step). In the division of the pressed sheet 1A, the pressed sheet 1A is cut along the thickness direction so that the pressed sheet 1A is divided into a plurality of pieces when the pressed sheet 1A is projected in the thickness direction. The pressed sheet 1A is cut so that the respective divided sheets 1B have the same shape when the divided sheets 1B are projected in the thickness direction.

Next, in this method, as shown in FIG. 3 (c), the respective divided sheets 1B are laminated in the thickness direction, thereby producing a laminated sheet 1C (laminating step).

Thereafter, in this method, as shown in FIG. 3 (a), the laminated sheet 1C is hot-pressed (preferably hot-pressed under vacuum) (hot-pressing step). The conditions for the hot-pressing are the same as the conditions for the hot-pressing of the above-described mixture.

The thickness of the hot-pressed laminated sheet 1C is, for example, 1 mm or less, or preferably 0.8 mm or less, and usually is, for example, 0.05 mm or more, or preferably 0.1 mm or more.

Thereafter, the series of the steps of the above-described dividing step (FIG. 3 (b)), laminating step (FIG. 3 (c)), and hot-pressing step (FIG. 3 (a)) are performed repeatedly, so as to allow boron nitride particles 17 to be efficiently oriented in a predetermined direction in the resin component 18 in the thermal conductive sheet 11. The number of the repetition is not particularly limited, and can be set appropriately according to the charging state of the boron nitride particles. The number of the repetition is, for example, 1 to 10 times, or preferably 2 to 7 times.

In the above-described hot-pressing step (FIG. 3 (a)), for example, a plurality of calendering rolls and the like can be used for rolling the mixture and the laminated sheet 1C.

The thermal conductive sheet 11 can be obtained in this manner

The thickness of the obtained thermal conductive sheet 11 is, for example, 1 mm or less, or preferably 0.8 mm or less, and usually, for example, 0.05 mm or more, or preferably 0.1 mm or more.

In the thermal conductive sheet 11, the proportion of the volume-based boron nitride particle content (solid content, that is, volume percentage of boron nitride particles relative to the total volume of the resin component and the boron nitride particles) is, as described above, for example, 35 vol % or more (preferably 60 vol % or more, or more preferably 75 vol % or more), and usually 95 vol % or less (preferably 90 vol % or less).

When the proportion of the boron nitride particle content is below the above-described range, the boron nitride particles 17 may not be oriented in a predetermined direction in the thermal conductive sheet 11.

When the resin component 18 is the thermosetting resin component, for example, the series of the steps of the above-described dividing step (FIG. 3 (b)), laminating step (FIG. 3 (c)), and hot-pressing step (FIG. 3 (a)) are performed repeatedly, obtaining as the thermal conductive sheet 11 in a state of semi-cured (in stage B).

In the thermal conductive sheet 11 thus obtained, as shown in FIG. 2 and its partially enlarged schematic view, the longitudinal direction LD of the boron nitride particle 17 is oriented efficiently along a plane (surface) direction SD that crosses (is perpendicular to) the thickness direction TD of the thermal conductive sheet 11.

The calculated average of the angle formed between the longitudinal direction LD of the boron nitride particle 17 and the plane direction SD of the thermal conductive sheet 11 (orientation angle α of the boron nitride particles 17 relative to the thermal conductive sheet 11) is, for example, 25 degrees or less, or preferably 20 degrees or less, and usually 0 degree or more.

The orientation angle α of the boron nitride particle 17 relative to the thermal conductive sheet 11 is obtained as follows: the thermal conductive sheet 11 is cut along the thickness direction with a cross section polisher (CP); the cross section thus appeared is photographed with a scanning electron microscope (SEM) at a magnification that enables observation of 200 or more boron nitride particles 17 in the field of view; a tilt angle α between the longitudinal direction LD of the boron nitride particle 17 and the plane direction SD (direction perpendicular to the thickness direction TD) of the thermal conductive sheet 11 is obtained from the obtained SEM photograph; and the average value of the tilt angles α is calculated.

Thus, the thermal conductivity in the plane direction SD of the thermal conductive sheet 11 is 4 W/m or more, preferably 5 W/m·K or more, more preferably 10 W/m·K or more, even more preferably 15 W/m·K or more, or particularly preferably 25 W/m·K or more, and usually 200 W/m·K or less.

The thermal conductivity in the plane direction SD of the thermal conductive sheet 11 is substantially the same before and after the curing by heat when the resin component 18 is the thermosetting resin component.

When the thermal conductivity in the plane direction SD of the thermal conductive sheet 11 is below the above-described range, thermal conductivity in the plane direction SD is insufficient, and therefore there may be a case where the thermal conductive sheet 11 cannot be used for heat dissipation that requires thermal conductivity in such a plane direction SD.

The thermal conductivity in the plane direction SD of the thermal conductive sheet 11 is measured by a pulse heating method. In the pulse heating method, the xenonflash analyzer “LFA-447” (manufactured by Erich NETZSCH GmbH & Co. Holding KG) is used.

The thermal conductivity in the thickness direction TD of the thermal conductive sheet 11 is, for example, 0.5 to 15 W/m·K, or preferably 1 to 10 W/m·K.

The thermal conductivity in the thickness direction TD of the thermal conductive sheet 11 is measured by a pulse heating method, a laser flash method, or a TWA method. In the pulse heating method, the above-described device is used, in the laser flash method, “TC-9000” (manufactured by Ulvac, Inc.) is used, and in the TWA method, “ai-Phase mobile” (manufactured by ai-Phase Co., Ltd) is used.

Thus, the ratio of the thermal conductivity in the plane direction SD of the thermal conductive sheet 11 relative to the thermal conductivity in the thickness direction TD of the thermal conductive sheet 11 (thermal conductivity in the plane direction SD/thermal conductivity in the thickness direction TD) is, for example, 1.5 or more, preferably 3 or more, or more preferably 4 or more, and usually 20 or less.

Although not shown in FIG. 2, for example, pores (gaps) are formed in the thermal conductive sheet 11.

The proportion of the pores in the thermal conductive sheet 11, that is, a porosity P, can be adjusted by setting the proportion of the boron nitride particle 17 content (volume-based), and further setting the temperature, the pressure, and/or the duration at the time of hot pressing the mixture of the boron nitride particle 17 and the resin component 18 (FIG. 2(a)). To be specific, the porosity P can be adjusted by setting the temperature, the pressure, and/or the duration of the hot pressing (FIG. 2(a)) within the above-described range.

The porosity P of the thermal conductive sheet 11 is, for example, 30 vol % or less, or preferably 10 vol % or less.

The porosity P is measured by, for example, as follows: the thermal conductive sheet 11 is cut along the thickness direction with a cross section polisher (CP); the cross section thus appeared is observed with a scanning electron microscope (SEM) at a magnification of 200 to obtain an image; the obtained image is binarized based on the pore portion and the non-pore portion; and the area ratio, i.e., the ratio of the pore portion area to the total area of the cross section of the thermal conductive sheet 11 is determined by calculation.

The thermal conductive sheet 11 has a porosity P2 after curing of, relative to a porosity P1 before curing, for example, 100% or less, or preferably 50% or less.

For the measurement of the porosity P (P1), when the resin component 18 is a thermosetting resin component, the thermal conductive sheet 11 before curing by heat is used.

When the porosity P of the thermal conductive sheet 11 is within the above-described range, the conformability to irregularities (described later) of the thermal conductive sheet 11 can be improved.

On the other hand, the thermal conductive sheet 11 does not fall off from an adherend in the initial adhesion test (1) described below. That is, a temporally fixed state between the thermal conductive sheet 11 and the adherend is kept.

Initial Adhesion Test (1): The thermal conductive sheet 11 is thermocompression bonded at 80° C. on top of an adherend that is placed along a horizontal direction to be temporary fixed thereon, allowed to stand for 10 minutes, and the adherend is turned over to be upside down.

Examples of the adherend include a substrate made of stainless steel (e.g., SUS 304 and the like), or a substrate made of the same material as that for the light-emitting diode 6.

In the pressure bonding, for example, while a sponge roll made of a resin such as silicone resin is pressed against the thermal conductive sheet 11, the sponge roll is rolled on the surface of the thermal conductive sheet 11.

The temperature of the thermocompression bonding is, when the resin component 18 is a thermosetting resin component (for example, epoxy resin), for example, 80° C.

On the other hand, when the resin component 18 is a thermoplastic resin component (for example, polyethylene), the temperature of the thermocompression bonding is a temperature higher by 10 to 30° C. than the softening point or the melting point of the thermoplastic resin component; preferably a temperature higher by 15 to 25° C. than the softening point or the melting point of the thermoplastic resin component; more preferably, a temperature higher by 20° C. than the softening point or the melting point of the thermoplastic resin component; or to be specific, a temperature of 120° C. (that is, the softening point or the melting point of the thermoplastic resin component is 100° C., and the temperature higher by 20° C. than 100° C. is 120° C.).

When the thermal conductive sheet 11 falls off from the adherend in the above-described initial adhesion test (1), that is, when the temporally fixed state between the thermal conductive sheet 11 and the adherend is not kept, there may be a case where the thermal conductive sheet 11 cannot be reliably temporally fixed to the adherend.

When the resin component 18 is a thermosetting resin component, the thermal conductive sheet 11 to be tested in the initial adhesion test (1) and the initial adhesion test (2) (described later) is a thermal conductive sheet 11 before curing, and the thermal conductive sheet 11 will be in B-stage based on the thermocompression bonding in the initial adhesion test (1) and the initial adhesion test (2).

When the resin component 18 is a thermoplastic resin component, the thermal conductive sheet 11 subjected to the initial adhesion test (1) and the initial adhesion test (2) (described later) is a solid thermal conductive sheet 11, and the thermal conductive sheet 11 is softened by the thermocompression bonding in the initial adhesion test (1) and the initial adhesion test (2).

Preferably, the thermal conductive sheet 11 does not fall off from the adherend in both of the above-described initial adhesion test (1) and the initial adhesion test (2) described below. That is, the temporally fixed state between the thermal conductive sheet 11 and the adherend is kept.

Initial Adhesion Test (2): the thermal conductive sheet 11 is thermocompression bonded on top of an adherend that is placed along a horizontal direction to be temporary fixed thereon, and then allowed to stand for 10 minutes, and thereafter, the adherend is disposed along a vertical direction (up-down direction).

The temperature in the thermocompression bonding of the Initial Adhesion Test (2) is the same as the temperature in the Initial Adhesion Test (1).

When the resin component 18 is a thermosetting resin component, the thermal conductive sheet 11 to be tested in the initial adhesion test (1) is a thermal conductive sheet 11 before curing, and the thermal conductive sheet 11 will be in B-stage based on the thermocompression bonding in the initial adhesion test (1).

In the thermal conductive sheet 11, the surface reflectance R with respect to the light of 500 nm is, for example, 70% or more, or preferably 75% or more, or more preferably 80% or more and usually 100% or less.

The surface reflectance R of the thermal conductive sheet 11 with respect to the light of 500 nm is the percentage when the surface reflectance of barium sulfate is 100%.

The surface reflectance R is measured by a spectral photometer. The measurement by the spectral photometer uses an integrating sphere and is performed with an incident angle of five degrees.

When the surface reflectance R of the thermal conductive sheet 11 is below the above-described range, there may be a case where the light of 500 nm emitted from the light-emitting diode 6 described later cannot be efficiently reflected.

In the thermal conductive sheet 11, when the resin component 18 is a thermosetting resin component, the surface reflectance R is the value of the thermal conductive sheet 11 after curing of it.

When the thermal conductive sheet 11 is evaluated in the bend test in conformity with the cylindrical mandrel method of JIS K 5600-5-1 under the test conditions shown below, preferably, no fracture is observed.

Test Conditions:
Test Device: Type I
Mandrel: diameter 10 mm
Bending Angle: 90 degrees or more
Thickness of the thermal conductive sheet 11: 0.3 mm

FIGS. 10 and 11 show perspective views of the Type I test device. In the following, the Type I test device is described.

In FIGS. 10 and 11, a Type I test device 90 includes a first flat plate 91; a second flat plate 92 disposed in parallel with the first flat plate 91; and a mandrel (rotation axis) 93 provided for allowing the first flat plate 91 and the second flat plate 92 to rotate relatively.

The first flat plate 91 is formed into a generally rectangular flat plate. A stopper 94 is provided at one end portion (free end portion) of the first flat plate 91. The stopper 94 is formed on the surface of the second flat plate 92 so as to extend along the one end portion of the second flat plate 92.

The second flat plate 92 is formed into a generally rectangular flat plate, and one side thereof is disposed so as to be adjacent to one side (the other end portion (proximal end portion) that is opposite to the one end portion where the stopper 94 is provided) of the first flat plate 91.

The mandrel 93 is formed so as to extend along one side of the first flat plate 91 and of the second flat plate 92 that are adjacent to each other.

In the Type I test device 90, as shown in FIG. 10, the surface of the first flat plate 91 is flush with the surface of the second flat plate 92 before the start of the bend test.

To perform the bend test, the thermal conductive sheet 11 is placed on the surface of the first flat plate 91 and the surface of the second flat plate 92. The thermal conductive sheet 11 is placed so that one side of the thermal conductive sheet 11 is in contact with the stopper 94.

Then, as shown in FIG. 11, the first flat plate 91 and the second flat plate 92 are rotated relatively. In particular, the free end portion of the first flat plate 91 and the free end portion of the second flat plate 92 are rotated to a predetermined angle with the mandrel 93 as the center. To be specific, the first flat plate 91 and the second flat plate 92 are rotated so as to bring the surface of the free end portions thereof closer (oppose each other).

In this way, the thermal conductive sheet 11 is bent with the mandrel 93 as the center, conforming to the rotation of the first flat plate 91 and the second flat plate 92.

More preferably, no fracture is observed in the thermal conductive sheet 11 even when the bending angle is set to 180 degrees under the above-described test conditions.

When the resin component 18 is the thermosetting resin component, the thermal conductive sheet 11 which is subjected to the bend test is the semi-cured (in stage B) thermal conductive sheet 11 (that is, the thermal conductive sheet 11 before curing by heat).

When the fracture is observed in the bend test at the above-described bending angle in the thermal conductive sheet 11, there may be a case where excellent flexibility cannot be given to the thermal conductive sheet 11.

Furthermore, for example, when the thermal conductive sheet 11 is evaluated in the 3-point bending test in conformity with JIS K 7171 (2008) under the test conditions shown below, no fracture is observed.

Test Conditions:
Test piece: size 20 mm×15 mm
Distance between supporting points: 5 mm
Testing speed: 20 mm/min (indenter depressing speed)
Bending angle: 120 degrees

Evaluation method: presence or absence of fracture such as cracks at the center of the test piece is observed visually when tested under the above-described test conditions.

In the 3-point bending test, when the resin component 18 is a thermosetting resin component, the thermal conductive sheet 11 before curing by heat is used.

Therefore, the thermal conductive sheet 11 is excellent in conformability to irregularities because no fracture is observed in the above-described 3-point bending test. The conformability to irregularities is, when the thermal conductive sheet 11 is provided on an object with irregularities, a property of the thermal conductive sheet 11 that conforms to be in close contact with the irregularities.

A mark such as, for example, letters and symbols can adhere to the thermal conductive sheet 11. That is, the thermal conductive sheet 11 is excellent in mark adhesion. The mark adhesion is a property of the thermal conductive sheet 11 that allows reliable adhesion of the above-described mark thereon.

The mark can be adhered (applied, fixed, or firmly fixed) to the thermal conductive sheet 11, to be specific, by printing, engraving, or the like.

Examples of printing include, for example, inkjet printing, relief printing, intaglio printing, and laser printing.

When the mark is to be printed by inkjet printing, relief printing, or intaglio printing, for example, an ink fixing layer for improving mark's fixed state can be provided on the surface (printing side, upper surface, opposite side to the back wall 8) of the thermal conductive sheet 11.

When the mark is to be printed by laser printing, for example, a toner fixing layer for improving mark's fixed state can be provided on the surface (printing side, upper surface, opposite side to the back wall 8) of the thermal conductive sheet 11.

Examples of engraving include laser engraving, and punching.

The casing 7 is first prepared to produce the back light 3. In the back wall 8 of the casing 7, a plurality of the first holes (not shown) are formed and the wiring pattern (not shown) is formed on the back surface of the back wall 8.

Next, the thermal conductive sheet 11 in stage B is cutout so as to be the same shape as the back wall 8 and to form a plurality of the second holes, and then the cutout one is laminated on the front surface of the back wall 8. The thermal conductive sheet 11 in stage B has flexibility, thereby being laminated on the front surface of the back wall 8 in close contact with the back wall 8.

Next, each of the light-emitting diodes 6 is provided on the front surface of the thermal conductive sheet 11. The light-emitting diodes 6 are provided on the front surface of the thermal conductive sheet 11 in stage B in close contact with the thermal conductive sheet 11. At this time, the light-emitting diodes 2 and the wiring pattern (not shown) are connected via the first holes (not shown) and the second holes (not shown).

Subsequently, the lens 10 is provided on the front surface of the light-emitting diodes 6.

Thereafter, the thermal conductive sheet 11 is cured by heat (completely cured by heat).

Heating conditions to completely cure the thermal conductive sheet 11 by heat are as follows: a heating temperature of, for example, 60 to 250° C., or preferably 80 to 200° C. and a heating duration of, for example, 5 to 200 minutes.

The thermal conductive sheet 11 which is completely cured by heat is adhered to the entire front surface of the back wall 8, the lower end portions of the inner surfaces of the side walls 9, and the back surfaces of the light-emitting diodes 6 without any space.

The back light 3 is prepared in this manner.

The liquid crystal display device 1 is obtained by arranging the liquid crystal panel 2 in opposed relation to the front side of the back light 3.

In the above-described back light 3, the heat generated in the light-emitting diodes 6 can be efficiently diffused along the plane direction SD of the thermal conductive sheet 11 by the heat diffusing member 5 made of the thermal conductive sheet 11. When the casing 7 is made of a metal material, the diffused heat is transferred to the casing 7 to be dissipated therefrom.

Thus, it is possible to prevent irregularity in temperature from occurring in the irradiating portion 4.

As a result, the above-described liquid crystal display device 1 is capable of preventing irregularity in temperature of the back light 3 from affecting the liquid crystal panel 2, thereby capable of improving the display performance.

Furthermore, the thermal conductive sheet 11 which forms the heat diffusing member 5 has the above-described surface reflectance R, so that the heat diffusing member 5 can serve as a light reflector for reflecting the light that the light-emitting diodes 6 emit. Therefore, the luminous efficiency of the back light 3 can be improved.

FIG. 4 shows a liquid crystal display device including another embodiment (embodiment of the direct type including a cold cathode fluorescent lamp) of the back light of the present invention. FIG. 5 shows a liquid crystal display device including another embodiment (embodiment of the direct type and the back wall of a casing being a wavy shape in cross section) of the back light of the present invention. FIG. 6 shows a liquid crystal display device including another embodiment (embodiment of the direct type and the back wall of the casing being a zig-zag shape in cross section) of the back light of the present invention. FIG. 7 shows a liquid crystal display device including another embodiment (embodiment of the direct type and the casings being provided corresponding to each of the light-emitting diodes) of the back light of the present invention. FIG. 8 shows a liquid crystal display device including another embodiment (embodiment of a side light type including the light-emitting diode) of the back light of the present invention. FIG. 9 shows a liquid crystal display device including another embodiment (embodiment of the side light type including the cold cathode fluorescent lamp) of the back light of the present invention.

In each figure to be described below, the same reference numerals are provided for members corresponding to each of those described above, and their detailed description is omitted.

In FIGS. 4 (a), 5 (a), 6 (a), 7 (a), 8 (a), and 9 (a), the liquid crystal panel 2 is omitted so as to clearly show the arrangement of a cold cathode fluorescent lamp 13, the light-emitting diodes 6, or a light guide plate 12.

In the above-described description, the light emitting diodes 6 are used as a light source. However, for example, as shown in FIG. 4, the cold cathode fluorescent lamp 13 can be used therefor.

The cold cathode fluorescent lamp 13 is a cold cathode type fluorescent lamp and is provided so as to be disposed to extend between both of the side walls 9 which are arranged in opposed relation to each other in the up-down direction. To be specific, the cold cathode fluorescent lamp 13 is formed into a tube shape extending in the up-down direction and a plurality thereof are arranged in parallel at spaced intervals to each other in the right-left direction. While the heat diffusing member 5 is laminated on the front surface of the casing 7 in close contact with the casing 7 in the same manner as described above, the cold cathode fluorescent lamps 13 are arranged in the front of the heat diffusing member 5 with a space therebetween.

In the back light 3, the air around each of the cold cathode fluorescent lamps 13 transfers the heat generated from the cold cathode fluorescent lamps 13 to the heat diffusing member 5. The transferred heat can be efficiently diffused along the plane direction SD of the thermal conductive sheet 11 by the heat diffusing member 5. When the casing 7 is made of a metal material, the diffused heat is transferred to the casing 7 to be dissipated therefrom.

Thus, it is possible to prevent irregularity in temperature from occurring in the irradiating portion 4.

As a result, the above-described liquid crystal display device 1 is capable of preventing irregularity in temperature of the back light 3 from affecting the liquid crystal panel 2, thereby capable of improving the display performance.

In the above-described description, the back wall 8 is formed into a flat plate shape. However, the shape thereof is not particularly limited and can be formed into, for example, a wavy shape in cross section (FIG. 5) or a zig-zag shape in cross section (FIG. 6). Furthermore, as shown in FIG. 5 (b) and FIG. 6 (b), the heat diffusing member 5 can be provided on the back surface of the back wall 8 and the outer surfaces (that is, the outer side surface of the casing 7) of the side walls 9.

In FIG. 5, the back wall 8 has a plurality of circular arc (to be specific, minor arc) portions 14 whose axis is each of the cold cathode fluorescent lamps 13. The circular arc portions 14 are formed so as to be continuous in the right-left direction. In this way, the back wall 8 is formed into a wavy shape in cross section.

In the outer end portions of the circular arc portions 14 corresponding to the cold cathode fluorescent lamps 13 which are disposed at the most outside in the right-left direction, the side walls 9 extend upward so as to slant outward.

The heat diffusing member 5 is continuously laminated on the back surface of the back wall 8 and the outer surfaces of the side walls 9 in close contact with the back wall 8 and the side walls 9.

When the thermal conductive sheet 11 is in stage B, it has flexibility (bendability), thereby capable of being deformed and laminated as conforming to the back wall 8 which has a complicated shape.

To prepare the back light 3, the cold cathode fluorescent lamps 13 are provided on the casing 7. Thereafter, the thermal conductive sheet 11 is laminated on the back surface (outer surface) of the casing 7 in close contact with the casing 7 and subsequently is cured by heat.

In the back light 3, the air surrounded by each of the circular arc portions 14 and the circular arc portions 14 transfer the heat generated from the cold cathode fluorescent lamps 13 to the heat diffusing member 5. The transferred heat can be efficiently diffused along the plane direction SD of the thermal conductive sheet 11 to be dissipated therefrom.

In FIG. 6, the back wall 8 has a plurality of V-shaped portions 16 which are arranged in opposed relation at spaced intervals to each of the cold cathode fluorescent lamps 13. The V-shaped portions 16 are formed so as to be continuous in the right-left direction. In this way, the back wall 8 is formed into a zig-zag shape in cross section.

The heat diffusing member 5 is continuously laminated on the back surface of the back wall 8 and the outer surfaces of the side walls 9 in close contact with the back wall 8 and the side walls 9.

In the back light 3, the air surrounded by each of the V-shaped portions 16 and a flat plate portion 15 transfer the heat generated from the cold cathode fluorescent lamps 13 to the heat diffusing member 5. The transferred heat can be efficiently diffused along the plane direction SD of the thermal conductive sheet 11 to be dissipated therefrom.

As shown in FIG. 7, a plurality of the casings 7 can be provided corresponding to a plurality of the light-emitting diodes 6.

As shown in FIG. 7 (a) and FIG. 7 (b), the back light 3 includes the irradiating portion 4 and the heat diffusing member 5, and the irradiating portion 4 includes the casings 7 which house each of the light-emitting diodes 6 and the light-emitting diodes 6.

The casing 7 is formed into a generally box shape with the upper side open and is formed into a generally U-shape in front sectional view. A plurality thereof are arranged in alignment in the right-left direction and the up-down direction.

Each of the casings 7 includes the back wall 8 and the side walls 9 which extend toward the front side from the circumference end portions of the back wall 8 so as to slant outward.

In the back wall 8, the first holes (not shown) and the wiring pattern (not shown), which are the same as described above, are formed.

Both end portions of the side walls 9 in the up-down direction (except for the most upper end portion and the most lower end portion) are connected to each other. Both end portions of the side walls 9 in the right-left direction (except for the most right end portion and the most left end portion) are connected to each other.

The light-emitting diode 6 is disposed on the front surface of the heat diffusing member 5 which is laminated on the front surface of the back wall 8 in close contact with the heat diffusing member 5.

The heat diffusing member 5 is laminated on the front surface of the casing 7. To be specific, the heat diffusing member 5 is continuously laminated so as to come into contact with the front surface of the back wall 8 and the inner surfaces of the side walls 9. In the heat diffusing member 5, the second holes (not shown) are formed at the same position as each of the first holes (not shown) in the back wall 8.

The light-emitting diode 6 is connected to the wiring pattern via the second holes and the first holes.

In the back light 3, the heat generated in the light-emitting diode 6 can be diffused along the plane direction SD of the thermal conductive sheet 11 by the heat diffusing member 5 in each of the casings 7. When each of the casings 7 is made of a metal material, the diffused heat is transferred to the casings 7 to be dissipated therefrom.

Thus, it is possible to prevent irregularity in temperature from occurring in the light-emitting diode 6 in each of the casings 7.

As a result, the above-described liquid crystal display device 1 is capable of preventing irregularity in temperature of the back light 3 from affecting the liquid crystal panel 2, thereby capable of improving the display performance.

Furthermore, the heat diffusing member 5 can serve as a light reflector, thereby capable of improving the luminous efficiency of the back light 3.

In addition, a reflection layer containing a reflection agent is separately laminated on the inner surface of the heat diffusing member 5, so that the reflection efficiency can be improved.

In the above-described description, the back light 3 is constructed as a direct type. However, as shown in FIGS. 8 and 9, the back light 3 can be constructed as a side light type (edge light type).

In FIG. 8, the back light 3 is constructed as a side light type, including the irradiating portion 4 and the heat diffusing member 5.

The irradiating portion 4 includes the light-emitting diode 6 as a light source and the light guide plate 12 as a light guide portion where the light from the light-emitting diode 6 is guided.

The light guide plate 12 is arranged in opposed relation to the back surface of the liquid crystal panel 2 and is formed into a generally rectangular flat plate shape in plane view. The light guide plate 12 is formed into a generally trapezoidal shape in plan sectional view in which the spacing between the front surface and the back surface (length of the front-rear direction) becomes narrower as going to the left. That is, the back surface of the light guide plate 12 slants with respect to the front surface and the back surface extends toward the left side so as to slant to the front side.

The light-emitting diode 6 is disposed to be adjacent to the right side of the right end portion (the end surface of the side where the spacing between the front surface and the back surface is the largest) of the light guide plate 12. A plurality of the light-emitting diodes 6 are arranged at spaced intervals along the up-down direction. The lens 10 is provided on the left side surface of the light-emitting diode 6.

The heat diffusing member 5 is laminated so as to be in contact with the entire back surface of the light guide plate 12.

In the back light 3, the light that the light-emitting diode 6 emits is guided by the light guide plate 12, and then the light guide 12 applies the light to the liquid crystal panel 2 from the entire right-left direction thereof and the entire up-down direction thereof.

Although the heat generated from the light-emitting diode 6 tends to locally concentrate on the right side end portion of the light guide plate 12, the heat can be diffused in the right-left direction by the heat diffusing member 5 in the back light 3.

Furthermore, the heat diffusing member 5 serves as a light reflector which reflects the light that the light-emitting diode 6 emits, so that the light can be reliably reflected between the back surface of the light guide plate 12 and the front surface of the heat diffusing member 5. Therefore, the luminous efficiency of the back light 3 can be improved.

In the side light type back light 3 described above, the light-emitting diode 6 is used as a light source. However, for example, as shown in FIG. 9, the cold cathode fluorescent lamps 13 can be used therefor.

In FIG. 9 (a), the cold cathode fluorescent lamps 13 are disposed to be adjacent to the right side of the right end portion of the light guide plate 12, extending along the up-down direction.

In the back light 3, the heat which also tends to locally concentrate on the right side end portion of the light guide plate 12 can be diffused along the right-left direction by the heat diffusing member 5.

### EXAMPLES

While the present invention will be described hereinafter in further detail with reference to Prepared Examples and Examples, the present invention is not limited to these Prepared Examples and Examples.

### Preparation of a Thermal Conductive Sheet

### Prepared Example 1

The components described below were blended, stirred, and allowed to stand at room temperature (23° C.) for one night, thereby allowing methyl ethyl ketone (dispersion medium for curing agent) to volatilize, thereby preparing a semi-solid mixture. The details of the components were as follows: 13.42 g of PT-110 (trade name, plate-like boron nitride particles, average particle size (light scattering method) 45 μm, manufactured by Momentive Performance Materials Inc.); 1.0 g of jER® 828 (trade name, bisphenol A epoxy resin, the first epoxy resin, liquid, epoxy equivalent 184 to 194 g/eqiv., softening temperature (ring and ball test) below 25° C., melt viscosity (80° C.) 70 mPa·s, manufactured by Japan Epoxy Resins Co., Ltd.); 2.0 g of EPPN-501HY (trade name, triphenylmethane epoxy resin, the second epoxy resin, solid, epoxy equivalent 163 to 175 g/eqiv., softening temperature (ring and ball test) 57 to 63° C., manufactured by NIPPON KAYAKU Co., Ltd.); and 3 g (solid content 0.15 g) (5 mass % relative to the total volume of jER® 828 and EPPN-501HY which are epoxy resins) of Curing Agent (a dispersion of 5 mass % Curezol® 2P4 MHZ-PW (trade name, 2-phenyl-4-methyl-5-hydroxymethyl imidazole, manufactured by Shikoku Chemicals Corporation) in methyl ethyl ketone).

In the above-described mixing formulation, the volume percentage (vol %) of the boron nitride particles relative to the total volume of the solid content excluding the curing agent (that is, the solid content of the boron nitride particles and epoxy resin) was 70 vol %.

Next, the obtained mixture was sandwiched by two silicone-treated releasing films, and then these were hot-pressed with a vacuum hot-press at 80° C. under an atmosphere (vacuum atmosphere) of 10 Pa with a load of 5 ton (20 MPa) for 2 minutes. A pressed sheet having a thickness of 0.3 mm was thus obtained (ref: FIG. 2 (a)).

Thereafter, the obtained pressed sheet was cut so as to be divided into a plurality of pieces when projected in the plane direction of the pressed sheet. Divided sheets were thus obtained (ref: FIG. 2 (b)). Next, the divided sheets were laminated in the thickness direction. A laminated sheet was thus obtained (ref: FIG. 2 (c)).

Then, the obtained laminated sheet was hot-pressed under the same conditions as described above with the above-described vacuum hot-press (ref: FIG. 2 (a)).

Then, a series of the above-described operations of cutting, laminating, and hot-pressing (ref: FIG. 2) was repeated four times. A thermal conductive sheet having a thickness of 0.3 mm (in stage B) was thus obtained (ref: FIG. 3).

### Prepared Examples 2 to 16

Thermal conductive sheets (Prepared Examples 2 to 16) were obtained in the same manner as in Prepared Example 1 in accordance with the mixing ratio and production conditions of Tables 1 to 3 (ref: FIG. 3).

### Production of a Back Light

### Example 1

A casing including a back wall and side walls was prepared. A plurality of first holes were formed in the back wall and a wiring pattern was formed so as to face the first holes on the back surface of the back wall.

Next, the thermal conductive sheet in stage B obtained in Prepared Example 1 was cutout into the shape which is the same shape as the back wall and to form a plurality of second holes, and then the cutout one was laminated on the front surface of the back wall in close contact with the back wall.

Thereafter, a light-emitting diode was provided on the front surface of the thermal conductive sheet in close contact with the thermal conductive sheet. At this time, the light-emitting diode and the wiring pattern were connected via the first holes and the second holes.

Subsequently, a lens was provided on the front surface of the light-emitting diode.

Thereafter, a heat diffusing member made of the thermal conductive sheet was formed by curing the thermal conductive sheet by heat (completely curing by heat) at 150° C. for 120 minutes. The heat diffusing member was adhered to the light-emitting diode and the back wall of a casing.

The back light was prepared in this manner (ref: FIG. 1).

### Examples 2 to 16

The back lights (Examples 2 to 16) including the thermal conductive sheet were formed in the same manner as in Example 1 except that each of the thermal conductive sheets of Prepared Examples 2 to 16 was used instead of the thermal conductive sheet of Prepared Example 1.

### Comparative Example 1

In producing the back light, the back light was produced in the same manner as in Example 1 except that the thermal conductive sheet was not laminated. The light-emitting diode was adhered to the front surface of the back wall via a silicone based adhesive.

### (Evaluation)

### 1. Thermal Conductivity

The thermal conductivity of the thermal conductive sheet of Example 1 was measured.

That is, the thermal conductivity in the plane direction (SD) was measured by a pulse heating method using a xenon flash analyzer “LFA-447” (manufactured by Erich NETZSCH GmbH & Co. Holding KG).

The results are shown in Tables 1 to 3.

### 2. Heat Dissipation

When operating the back lights of Examples 1 to 16 and Comparative Example 1, the temperature of the heat diffusing member and the back wall was measured by an infrared camera.

As a result, it was confirmed that there was almost no increase and irregularity in temperature of the heat diffusing member in Examples 1 to 16 compared to Comparative Example 1.

### 3. Initial Adhesion Test

### 3-1. Initial Adhesion Test for Mounting Substrate for Notebook PC

Initial adhesion tests (1) and (2) of the uncured thermal conductive sheet in Prepared Examples 1 to 16 to a mounting substrate for notebook PC on which a plurality of electronic components are mounted were conducted.

That is, the thermal conductive sheet was temporally fixed to the surface (the side on which the electronic components are mounted) along the horizontal direction of the mounting substrate for notebook PC using a sponge roll made of silicone resin by thermocompression bonding at 80° C. (Prepared Examples 1 to 9 and Prepared Examples 11 to 16) or 120° C. (Prepared Example 10), and then allowed to stand for 10 minutes, and thereafter, the mounting substrate for notebook PC was disposed along the up-down direction (Initial Adhesion Test (2)).

Afterwards, the mounting substrate for notebook PC was positioned so that the thermal conductive sheet faces downward (that is, turned over to be upside down from the position of the temporally fixing) (Initial Adhesion Test (1)).

Then, in the above-described Initial Adhesion Test (1) and Initial Adhesion Test (2), the thermal conductive sheet was evaluated based on the criteria below. The results are shown in Tables 1 to 3.

### <Criteria>

Good: It was confirmed that the thermal conductive sheet did not fall off from the mounting substrate for notebook PC.
Bad: It was confirmed that the thermal conductive sheet fell off from the mounting substrate for notebook PC.

### 3-2. Initial Adhesion Test to Stainless Steel Substrate

Initial adhesion tests (1) and (2) were conducted in the same manner as described above for adhesion of the uncured thermal conductive sheet of Prepared Examples 1 to 16 to a stainless steel substrate (made of SUS 304).

Then, in the above-described Initial Adhesion Test (1) and Initial Adhesion Test (2), the thermal conductive sheet was evaluated based on the criteria below. The results are shown in Tables 1 to 3.

### <Criteria>

Good: It was confirmed that the thermal conductive sheet did not fall off from the stainless steel substrate.
Bad: It was confirmed that the thermal conductive sheet fell off from the stainless steel substrate.

### 4. Surface Reflectance

The surface reflectance (R) of the thermal conductive sheets of Prepared Examples 1 to 16 with respect to the light of 500 nm was measured.

That is, the surface reflectance (R) was measured using a spectral photometer (U4100, manufactured by Hitachi High-Technologies Corporation) with an incident angle of five degrees. The surface reflectance (R) of the thermal conductive sheet was measured, using an integrating sphere, by allowing the reflectance of barium sulfate powder to be the criteria (that is, 100%) for the surface reflectance.

After the thermal conductive sheet (in stage B) was heated at 150° C. for 120 minutes to be cured by heat (completely cured by heat), the cured sheet was subjected to the measurement of the surface reflectance.

The results are shown in Tables 1 to 3.

### 5. Porosity (P)

The porosity (P1) of the uncured thermal conductive sheets of Prepared Examples 1 to 16 was measured by the following method.

Measurement method of porosity: The thermal conductive sheet was cut along the thickness direction with a cross section polisher (CP); and the cross section thus appeared was observed with a scanning electron microscope (SEM) at a magnification of 200. The obtained image was binarized based on the pore portion and the non-pore portion; and the area ratio, i.e., the ratio of the pore portion area to the total area of the cross section of the thermal conductive sheet was calculated.

The results are shown in Tables 1 to 3.

### 6. Conformability to Irregularities (3-Point Bending Test)

The 3-point bending test in conformity with JIS K 7171 (2010) was carried out for the uncured thermal conductive sheets of Prepared Examples 1 to 16 with the following test conditions, thus evaluating conformability to irregularities with the following evaluation criteria. The results are shown in Tables 1 to 3.

Test Conditions:
Test Piece: size 20 mm×15 mm
Distance Between Supporting Points: 5 mm
Testing Speed: 20 mm/min (indenter depressing speed)
Bending Angle: 120 degrees
Bending Angle: 90 degrees

### (Evaluation Criteria)

Excellent: No fracture was observed.
Good: Almost no fracture was observed.
Bad: Fracture was clearly observed.

### 7. Printed Mark Visibility (Mark Adhesion by Printing: Mark Adhesion by Inkjet Printing or Laser Printing)

Marks were printed on the uncured thermal conductive sheets of Prepared Examples 1 to 16 by inkjet printing and laser printing, and the mark was observed.

As a result, it was confirmed that the mark was excellently visible in both cases of inkjet printing and laser printing, and that mark adhesion by printing was excellent in any of the thermal conductive sheets of Prepared Examples 1 to 16.

TABLE 1

| | | | | | Prepared Examples | | | | | |
|---|---|---|---|---|---|---|---|---|---|---|
| | | | | Average Particle | Prepared | Prepared | Prepared | Prepared | Prepared | Prepared |
| | | | | Size | Example | Example | Example | Example | Example | Example |
| | | | | (μm) | 1 | 2 | 3 | 4 | 5 | 6 |
| Mixing | Boron Nitride | PT-110^{1} | | 45 | 13.42 | 3.83 | 5.75 | 12.22 | 23 | — |
| Formulation | Particles/g*^{A}/ | | | | [70] | [40] | [50] | [68] | [80] | |
| of | [vol %]*^{B}/ | | | | [69] | [38.8] | [48.8] | [66.9] | [79.2] | |
| Components | [vol %]*^{C} | UHP-1^{2} | | 9 | — | — | — | — | — | 12.22 |
| | | | | | | | | | | [68] |
| | | | | | | | | | | [66.9] |
| | Polymer | Thermo- | Epoxy resin | Epoxy Resin A^{3} | — | 3 | 3 | 3 | 3 | 3 |
| | | setting | Composition | (Semi-solid) | | | | | | |
| | | Resin | | Epoxy Resin B^{4} | 1 | — | — | — | — | — |
| | | | | (Liquid) | | | | | | |
| | | | | Epoxy Resin C^{5} | — | — | — | — | — | — |
| | | | | (Solid) | | | | | | |
| | | | | Epoxy Resin D^{6} | 2 | — | — | — | — | — |
| | | | | (Solid) | | | | | | |
| | | | | Curing Agent^{7} | — | 3 | 3 | 3 | 3 | 3 |
| | | | | (Solid Content in | | (0.15) | (0.15) | (0.15) | (0.15) | (0.15) |
| | | | | Grams) | | | | | | |
| | | | | Curing Agent^{8} | 3 | — | — | — | — | — |
| | | | | (Solid Content | (0.15) | | | | | |
| | | | | in Grams) | | | | | | |

| | | | | | | | |
|---|---|---|---|---|---|---|---|
| Thermo- | Polyethylene^{9} | — | — | — | — | — | — |
| plastic | | | | | | | |
| Resin | | | | | | | |

| Production | Heat Pressing | Temperature (° C.) | | | 80 | 80 | 80 | 80 | 80 | 80 |
|---|---|---|---|---|---|---|---|---|---|---|
| Conditions | | Number of Time (Times)*^{D} | | | 5 | 5 | 5 | 5 | 5 | 5 |
| | | Load (MPa)/(tons) | | | 20/5 | 20/5 | 20/5 | 20/5 | 20/5 | 20/5 |
| Evaluation | Thermal | Thermal Conductivity | Plane Direction | | 30 | 4.5 | 6.0 | 30.0 | 32.5 | 17.0 |
| | Conductive | (W/m · K) | (SD) | | | | | | | |
| | Sheet | | Thickness Direction | | 2.0 | 1.3 | 3.3 | 5.0 | 5.5 | 5.8 |
| | | | (TD) | | | | | | | |
| | | | Ratio | | 15.0 | 3.5 | 1.8 | 6.0 | 5.9 | 2.9 |
| | | | (SD/TD) | | | | | | | |
| | | Initial Adhesion Test | To Mounting | Test (1) | Good | Good | Good | Good | Good | Good |
| | | | Substrate for | Test (2) | Good | Good | Good | Good | Good | Good |
| | | | Notebook PC | | | | | | | |
| | | | To Stainless Steel | Test (1) | Good | Good | Good | Good | Good | Good |
| | | | Substrate | Test (2) | Good | Good | Good | Good | Good | Good |

| | | | | | | | |
|---|---|---|---|---|---|---|---|
| | Surface Reflectance (%) | 83 | 71 | 72 | 80 | 90 | 73 |
| | (Surface Reflectance to BaSo₄) | | | | | | |
| | Porosity (vol %) | 4 | 0 | 0 | 5 | 12 | 6 |
| | Conformability to Irregularities/3-point | EXCEL- | Good | Good | Good | Good | Good |
| | Bending Test | LENT | | | | | |
| | JIS K 7171 (2008) | | | | | | |
| | Volume Resistivity (Ω · cm) | 2 × 10¹⁴ | 5.5 × 10¹⁴ | 3.4 × 10¹⁴ | 2.1 × 10¹⁴ | 1.3 × 10¹⁴ | 1.7 × 10¹⁴ |
| | JIS K 6911 (2006) | | | | | | |
| Boron Nitride | Orientation Angle (α)(Degrees) | 12 | 18 | 18 | 15 | 13 | 20 |
| Particles | | | | | | | |

g*^{A}: Blended Weight
[vol %]*^{B}: Percentage relative to the Total Volume of the Thermal Conductive Sheet (excluding curing agent)
[vol %]*^{C}: Percentage relative to the Total Volume of the Thermal Conductive Sheet
Number of Time*^{D}: Number of Times of Heat Pressing of the Laminated Sheet

TABLE 2

| | | | | | Prepared Examples | | | | |
|---|---|---|---|---|---|---|---|---|---|
| | | | | Average Particle | Prepared | Prepared | Prepared | Prepared | Prepared |
| | | | | Size | Example | Example | Example | Example | Example |
| | | | | (μm) | 7 | 8 | 9 | 10 | 11 |
| Mixing | Boron Nitride | PT-110^{1} | | 45 | 12.22 | 12.22 | 12.22 | 3.83 | 13.42 |
| Formulation | Particles/g*^{A}/ | | | | [68] | [68] | [68] | [60] | [70] |
| of | [vol %]*^{B}/ | | | | [66.9] | [66.9] | [66.9] | [60] | [69] |
| Components | [vol %]*^{C} | UHP-1^{2} | | 9 | — | — | — | — | — |
| | Polymer | Thermosetting | Epoxy resin | Epoxy Resin A^{3} | — | — | — | — | — |
| | | Resin | Composition | (Semi-solid) | | | | | |
| | | | | Epoxy Resin B^{4} | 1.5 | 3 | — | — | — |
| | | | | (Liquid) | | | | | |
| | | | | Epoxy Resin C^{5} | 1.5 | — | 3 | — | — |
| | | | | (Solid) | | | | | |
| | | | | Epoxy Resin D^{6} | — | — | — | — | 3 |
| | | | | (Solid) | | | | | |
| | | | | Curing Agent^{7} | 3 | 3 | 3 | — | 3 |
| | | | | (Solid Content in | (0.15) | (0.15) | (0.15) | | (0.15) |
| | | | | Grams) | | | | | |
| | | | | Curing Agent^{8} | — | — | — | — | — |
| | | | | (Solid Content | | | | | |
| | | | | in Grams) | | | | | |

| | | | | | | |
|---|---|---|---|---|---|---|
| Thermoplastic | Polyethylene^{9} | — | — | — | 1 | — |
| Resin | | | | | | |

| Production | Heat Pressing | Temperature (° C.) | | | 80 | 80 | 80 | 120 | 80 |
|---|---|---|---|---|---|---|---|---|---|
| Conditions | | Number of Time (Times)*^{D} | | | 5 | 5 | 5 | 5 | 5 |
| | | Load (MPa)/(tons) | | | 20/5 | 20/5 | 20/5 | 4/1 | 20/5 |
| Evaluation | Thermal | Thermal Conductivity | Plane Direction | | 30.0 | 30.0 | 30.0 | 20 | 24.5 |
| | Conductive | (W/m · K) | (SD) | | | | | | |
| | Sheet | | Thickness Direction | | 5.0 | 5.0 | 5.0 | 2.0 | 2.1 |
| | | | (TD) | | | | | | |
| | | | Ratio | | 6.0 | 6.0 | 6.0 | 10.0 | 11.7 |
| | | | (SD/TD) | | | | | | |
| | | Initial Adhesion Test | To Mounting | Test (1) | Good | Good | Good | Good | Good |
| | | | Substrate for | Test (2) | Good | Good | Good | Good | Good |
| | | | Notebook PC | | | | | | |
| | | | To Stainless Steel | Test (1) | Good | Good | Good | Good | Good |
| | | | Substrate | Test (2) | Good | Good | Good | Good | Good |

| | | | | | | |
|---|---|---|---|---|---|---|
| | Surface Reflectance (%) | 83 | 82 | 83 | 76 | 83 |
| | (Surface Reflectance to BaSo₄) | | | | | |
| | Porosity (vol %) | 4 | 2 | 13 | 1 | 10 |
| | Conformability to Irregularities/3-point Bending Test | Good | Good | Bad | Bad | Bad |
| | JIS K 7171 (2008) | | | | | |
| | Volume Resistivity (Ω · cm) | 2.2 × 10¹⁴ | 2.4 × 10¹⁴ | 1.1 × 10¹⁴ | 4.1 × 10¹⁴ | 1.3 × 10¹⁴ |
| | JIS K 6911 (2006) | | | | | |
| Boron Nitride | Orientation Angle (α)(Degrees) | 12 | 18 | 18 | 15 | 13 |
| Particles | | | | | | |

g*^{A}: Blended Weight
[vol %]*^{B}: Percentage relative to the Total Volume of the Thermal Conductive Sheet (excluding curing agent)
[vol %]*^{C}: Percentage relative to the Total Volume of the Thermal Conductive Sheet
Number of Time*^{D}: Number of Times of Heat Pressing of the Laminated Sheet

TABLE 3

| | | | | | Prepared Examples | | | | |
|---|---|---|---|---|---|---|---|---|---|
| | | | | Average Particle | Prepared | Prepared | Prepared | Prepared | Prepared |
| | | | | Size | Example | Example | Example | Example | Example |
| | | | | (μm) | 12 | 13 | 14 | 15 | 16 |
| Mixing | Boron Nitride | PT-110^{1} | | 45 | 3.83 | 13.42 | 13.42 | 13.42 | 13.42 |
| Formulation | Particles/g*^{A}/ | | | | [40] | [70] | [70] | [70] | [70] |
| of | [vol %]*^{B}/ | | | | [37.7] | [69] | [69] | [69] | [69] |
| Components | [vol %]*^{C} | UHP-1^{2} | | 9 | — | — | — | — | — |
| | Polymer | Thermosetting | Epoxy resin | Epoxy Resin A^{3} | 3 | 3 | 3 | 3 | 3 |
| | | Resin | Composition | (Semi-solid) | | | | | |
| | | | | Epoxy Resin B^{4} | — | — | — | — | — |
| | | | | (Liquid) | | | | | |
| | | | | Epoxy Resin C^{5} | — | — | — | — | — |
| | | | | (Solid) | | | | | |
| | | | | Epoxy Resin D^{6} | — | — | — | — | — |
| | | | | (Solid) | | | | | |
| | | | | Curing Agent^{7} | 6 | 3 | 3 | 3 | 3 |
| | | | | (Solid Content in | (0.3) | (0.15) | (0.15) | (0.15) | (0.15) |
| | | | | Grams) | | | | | |
| | | | | Curing Agent^{8} | — | — | — | — | — |
| | | | | (Solid Content | | | | | |
| | | | | in Grams) | | | | | |

| | | | | | | |
|---|---|---|---|---|---|---|
| Thermoplastic | Polyethylene^{9} | — | — | — | — | — |
| Resin | | | | | | |

| Production | Heat Pressing | Temperature (° C.) | | | 80 | 60 | 70 | 80 | 80 |
|---|---|---|---|---|---|---|---|---|---|
| Conditions | | Number of Time (Times)*^{D} | | | 5 | 5 | 5 | 5 | 5 |
| | | Load (MPa)/(tons) | | | 20/5 | 20/5 | 20/5 | 20/5 | 40/10 |
| Evaluation | Thermal | Thermal Conductivity | Plane Direction | | 4.1 | 10.5 | 11.2 | 32.5 | 50.7 |
| | Conductive | (W/m · K) | (SD) | | | | | | |
| | Sheet | | Thickness Direction | | 1.1 | 2.2 | 3.0 | 5.5 | 7.3 |
| | | | (TD) | | | | | | |
| | | | Ratio | | 3.7 | 4.8 | 3.7 | 5.9 | 6.9 |
| | | | (SD/TD) | | | | | | |
| | | Initial Adhesion Test | To Mounting | Test (1) | Good | Good | Good | Good | Good |
| | | | Substrate for | Test (2) | Good | Good | Good | Good | Good |
| | | | Notebook PC | | | | | | |
| | | | To Stainless Steel | Test (1) | Good | Good | Good | Good | Good |
| | | | Substrate | Test (2) | Good | Good | Good | Good | Good |

| | | | | | | |
|---|---|---|---|---|---|---|
| | Surface Reflectance (%) | 72 | 81 | 81 | 83 | 82 |
| | (Surface Reflectance to BaSo₄) | | | | | |
| | Porosity (vol %) | 0 | 29 | 26 | 8 | 3 |
| | Conformability to Irregularities/3-point Bending Test | EXCEL- | EXCEL- | EXCEL- | EXCEL- | Good |
| | JIS K 7171 (2008) | LENT | LENT | LENT | LENT | |
| | Volume Resistivity (Ω · cm) | 6.4 × 10¹⁴ | 0.6 × 10¹⁴ | 0.8 × 10¹⁴ | 2.5 × 10¹⁴ | 5.3 × 10¹⁴ |
| | JIS K 6911 (2006) | | | | | |
| Boron Nitride | Orientation Angle (α)(Degrees) | 20 | 17 | 15 | 15 | 13 |
| Particles | | | | | | |

g*^{A}: Blended Weight
[vol %]*^{B}: Percentage relative to the Total Volume of the Thermal Conductive Sheet (excluding curing agent)
[vol %]*^{C}: Percentage relative to the Total Volume of the Thermal Conductive Sheet
Number of Time*^{D}: Number of Times of Heat Pressing of the Laminated Sheet

In Tables 1 to 3, values for the components are in grams unless otherwise specified.

In the rows of “boron nitride particles” in Tables 1 to 3, values on the top represent the blended weight (g) of the boron nitride particles; values in the middle represent the volume percentage (vol %) of the boron nitride particles relative to the total volume of the solid content excluding the curing agent in the thermal conductive sheet (that is, solid content of the boron nitride particles, and epoxy resin or polyethylene); and values at the bottom represent the volume percentage (vol %) of the boron nitride particles relative to the total volume of the solid content in the thermal conductive sheet (that is, solid content of boron nitride particles, epoxy resin, and curing agent).

For the components with “*” added in Tables 1 to 3, details are given below.

PT-110*¹: trade name, plate-like boron nitride particles, average particle size (light scattering method) 45 μm, manufactured by Momentive Performance Materials Inc.
UHP-1*²: trade name: SHOBN®UHP-1, plate-like boron nitride particles, average particle size (light scattering method) 9 μm, manufactured by Showa Denko K. K.
Epoxy Resin A*³: OGSOL EG (trade name), bisarylfluorene epoxy resin, semi-solid, epoxy equivalent 294 g/eqiv., softening temperature (ring and ball test) 47° C., melt viscosity (80° C.) 1360 mPa·s, manufactured by Osaka Gas Chemicals Co., Ltd.
Epoxy Resin B*⁴: jER® 828 (trade name), bisphenol A epoxy resin, liquid, epoxy equivalent 184 to 194 g/eqiv., softening temperature (ring and ball test) below 25° C., melt viscosity (80° C.) 70 mPa·s, manufactured by Japan Epoxy Resins Co., Ltd.
Epoxy Resin C*⁵: jER® 1002 (trade name), bisphenol A epoxy resin, solid, epoxy equivalent 600 to 700 g/eqiv., softening temperature (ring and ball test) 78° C., melt viscosity (80° C.) 10000 mPa·s or more (measurement limit or more), manufactured by Japan Epoxy Resins Co., Ltd.
Epoxy Resin D*⁶: EPPN-501HY (trade name), triphenylmethane epoxy resin, solid, epoxy equivalent 163 to 175 g/eqiv., softening temperature (ring and ball test) 57 to 63° C., manufactured by NIPPON KAYAKU Co., Ltd.
Curing Agent*⁷: a solution of 5 mass % Curezol® 2PZ (trade name, manufactured by Shikoku Chemicals Corporation) in methyl ethyl ketone.
Curing Agent*⁸: a dispersion of 5 mass % Curezol® 2P4 MHZ-PW (trade name, manufactured by Shikoku Chemicals Corporation) in methyl ethyl ketone.
Polyethylene*⁹: low density polyethylene, weight average molecular weight (Mw) 4000, number average molecular weight (Mn) 1700, melting point 100° C. to 105° C., manufactured by Sigma-Aldrich Co.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A back light comprising:
an irradiating portion for applying light to a liquid crystal panel; and
a heat diffusing member which is in contact with the irradiating portion; wherein
the heat diffusing member is made of a thermal conductive sheet containing a plate-like boron nitride particle; and
the thermal conductivity in a direction perpendicular to the thickness direction of the thermal conductive sheet is 4 W/m·K or more.

2. The back light according to claim 1, wherein
the irradiating portion includes a light source; and
the heat diffusing member is in contact with the light source.

3. The back light according to claim 2, wherein
the irradiating portion further includes a casing which houses the light source; and
the heat diffusing member is in contact with the inner side surface of the casing.

4. The back light according to claim 1, wherein
the irradiating portion includes a light source and a casing which houses the light source; and
the heat diffusing member is in contact with the outer side surface of the casing.

5. The back light according to claim 1, wherein
the irradiating portion includes a light source and a light guide portion where the light from the light source is guided; and
the heat diffusing member is in contact with the light guide portion.

6. The back light according to claim 1, wherein
the heat diffusing member serves as a light reflector for reflecting light.

7. A liquid crystal display device comprising:
a liquid crystal panel and a back light; wherein
the back light includes an irradiating portion for applying light to a liquid crystal panel; and
a heat diffusing member which is in contact with the irradiating portion; wherein
the heat diffusing member is made of a thermal conductive sheet containing a plate-like boron nitride particle; and
the thermal conductivity in a direction perpendicular to the thickness direction of the thermal conductive sheet is 4 W/m·K or more.
